(19) United States
(12) Patent Application Publication
(10) Pub. No.: US 2012/0237172 A1
(43) Pub. Date: Sep. 20, 2012

(54) OPTICAL-FIBER MECHANICAL SPLICER USING HEAT-SHRINK FERRULE

(75) Inventors: David Zhi CHEN, Richardson, TX (US); Mark A. ALI, Cockeysville, MD (US); George N. BELL, Stormville, NY (US)

(73) Assignee: VERIZON PATENT AND LICENSING INC., Basking Ridge, NJ (US)

(21) Appl. No.: 13/050,045

(22) Filed: Mar. 17, 2011

(51) Int. Cl. G02B 6/255; G02B 6/25

(52) U.S. Cl. 385/95; 225/1; 29/869

(57) ABSTRACT

Apparatus and methodology for providing a mechanical-only splice between two optical glass fibers. No fusion splicing is involved. A heat-shrinkable plastic ferrule containing an aperture extending from one end of the ferrule to the other accepts a different cleaved and cleaned optical fiber into each of its two ends, the fibers meeting at or near the middle of the ferrule in a parallel or coplanar manner forming a splice junction. Index matching gel is applied to at least one of the fiber ends before entering the aperture. Heat is applied to the ferrule to shrink it upon the portion of the two fibers within the ferrule (sealed fibers) and hold the splice junction in place. Epoxy can be applied to both ends of the ferrule to further seal the fiber splice junction, and to further enhance its integrity. If both fibers are sliced on an angle other than 90 degrees, when they touch inside the ferrule they are automatically coplanar without requiring intervening orientation.

### BACKGROUND

An optical glass fiber is usually defined as a glass core encapsulated by glass cladding encapsulated by a buffer coating; however, for this document, an optical glass fiber shall mean only the glass core encapsulated by the glass cladding. Optical glass fibers are tiny, the cladded cores having outside diameters on the order of 125 microns (μm), where one micron is one-thousandth of a millimeter or about 0.000039 inches. Although tiny, a glass fiber can carry a vast quantity of communication information as part of an optical network. From time to time, these glass fibers may need to be spliced together in the field during installation or when making modifications. One splicing technique, called fusion splicing, is analogous to welding two pieces of metal together, and involves an electrical arc that melts the glass at the ends of the two fused-together fibers. Although a fusion splice is a high quality splice, with relatively low insertion loss (low signal loss) at the junction of the splice, it takes a relatively long time to accomplish, perhaps as much as 45 minutes per splice.

A mechanical splice of an optical fiber requires far less time than that required by a fusion splice. For an installation of a large number of fiber optic cables requiring splicing, where each cable includes a number of buffer tubes, and where each buffer tube contains approximately twelve to twenty-two protectively-coated individual optical fibers, a significant manpower and cost savings can be achieved by using mechanical splicing instead of fusion splicing. But since mechanical splicing uses only physical contact between two endfaces (surfaces) of two different optical glass fibers, without melting the glass, and because of the inherently small dimensions involved, quality mechanical splicing can be hard to accomplish. Not only can the actual mechanical splicing be a challenge, particularly when the interface between the two mated optical fibers is intentionally angled relative to direction of optical signal transmission through the fibers (to mitigate reflections from that interface), but securely retaining that mechanical splice afterwards can be problematic because the butted-together optical fibers can be pulled and/or twisted apart.

What is needed is an advantageous way of making a quality mechanical splice between two optical fibers resulting in a low insertion loss junction, providing automatic alignment between the two fibers when they have end faces that are angled and providing sturdy and secure mechanical splice-junctions that cannot be inadvertently pulled and/or twisted apart after the mechanical splicing procedure is completed.

### BRIEF DESCRIPTION OF THE DRAWINGS

FIG. 1 is an exemplary schematic diagram of a plastic ferrule in accordance with an exemplary embodiment;

FIG. 2 is a cross-sectional view of the embodiment of FIG. 1;

FIG. 3 is the cross-sectional view of FIG. 2, but showing glass fibers inserted into the ferrule;

FIG. 4 is an exemplary schematic diagram of a top view of optical fiber mechanical splicing apparatus in accordance with an exemplary embodiment;

FIG. 5 is the exemplary schematic diagram of FIG. 4, but with optical fiber holders, optical fiber slicers and ferrule holder removed to more clearly show a portion of the floor of the holder/slicer retention channel or track formed in the chassis of such apparatus;

FIG. 6 is an exemplary schematic diagram depicting a rear elevation view of FIG. 4, but showing only one optical fiber slicer in the channel;

FIG. 7 is an exemplary schematic diagram depicting a side elevation view of an optical fiber holder used in FIG. 4 and constructed in accordance with an exemplary embodiment;

FIG. 8 is an exemplary schematic diagram depicting a side elevation view of a plastic ferrule holder used in FIG. 4 and constructed in accordance with an exemplary embodiment;

FIG. 9 is an exemplary schematic diagram depicting a side elevation view of an optical fiber slicer of the type used in FIG. 4 and constructed in accordance with an exemplary embodiment;

FIG. 10 is a flowchart of various steps used to achieve only a pure mechanical splice (no fusion splice) between two optical fibers in accordance with an exemplary embodiment;

FIG. 11 is a cross-sectional view of one end of another plastic ferrule embodiment in accordance with an exemplary embodiment, this plastic ferrule being similar to that of FIG. 3 but also engaging the buffer coating of one of the optical fibers spliced inside the ferrule in a manner to protect a portion of that optical fiber which otherwise would be exposed; and

FIG. 12 is an exemplary schematic diagram of an alternative configuration of the slicer of FIG. 6.

### DETAILED DESCRIPTION OF PREFERRED EMBODIMENTS

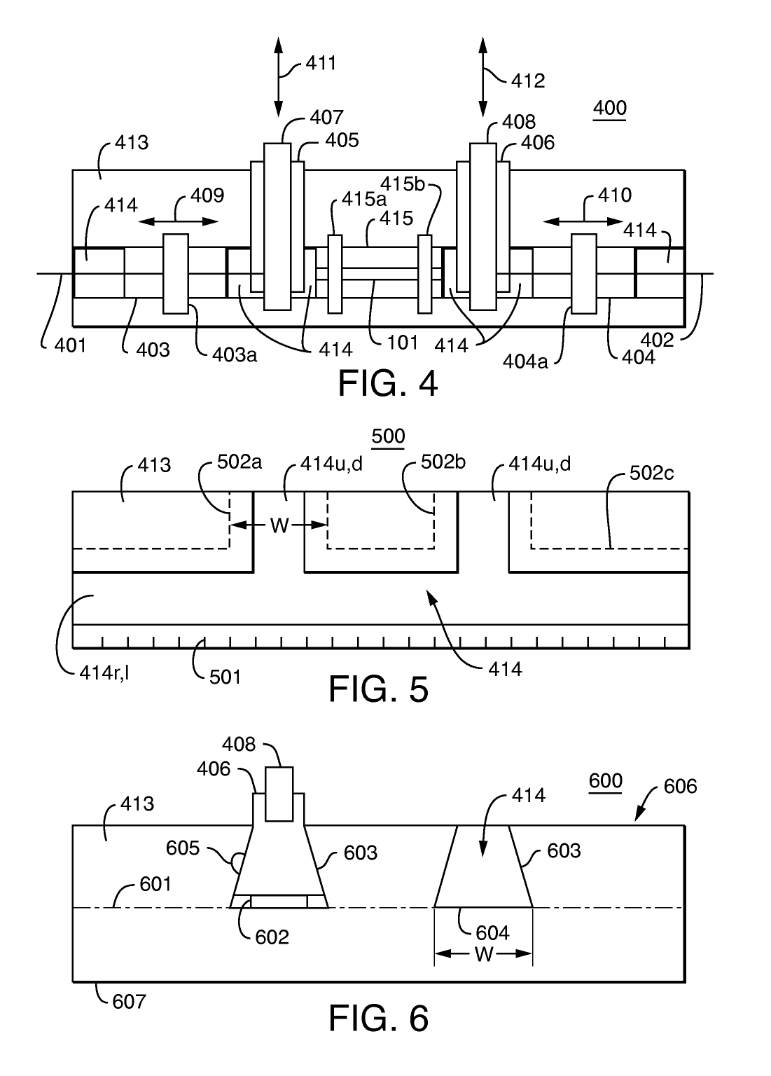

In this description, the same reference numeral in different Figs. refers to the same entity. Otherwise, reference numerals of each Fig. start with the same number as the number of that Fig. For example, FIG. 3 has numerals in the “300” category and FIG. 4 has numerals in the “400” category, etc.

In overview, exemplary embodiments include apparatus and/or methodology for heat shrinking a plastic ferrule (a plastic tube with a cylindrically shaped tunnel or aperture formed there-through) upon two different optical fibers that had previously been cleaved at the same suitable angle and, after applying index matching gel to one, or both, of the cleaved surfaces, were mated together within the aperture inside the plastic ferrule. An optical fiber technician can perform the cleaving and the gel application and can also substantially perform the mating together within the aperture where the two cleaved ends are manually pressed towards and against each other. This heat shrink process obtains a permanent, robust and mechanical-only (non-fusion) optical fiber splice junction. The cleaved ends at the splice junction are co-planar or, if the ends are separated by index matching gel the cleaved ends are parallel and almost coplanar. If the junction is no longer needed or desired, the two optical fibers can be cut away from the ferrule, and the used ferrule can be discarded; reuse of the used ferrule is not contemplated.

The two different optical fibers need not have identical diameters, and need not be perfectly cylindrical. The effect of heat shrinking the plastic ferrule creates various forces upon the optical fibers such as causing compressive and frictional forces upon the outer longitudinal surfaces of the optical fibers, regardless of any surface deviations from cylindrical that they might have. For purely cylindrical optical fibers, those surface compression forces are directed radially towards the axes of rotation of those cylinders. The frictional forces, derived from thermal contraction of the ferrule, are longitudinally directed and tend to further push the two fibers towards each other, whereby the two cleaved ends tend to be further compressed against each other beyond that compression achieved by manual insertion of the fibers by the optical fiber technician, thereby further reducing insertion loss. In other words, as the fibers cool after the heat used in the heat shrink process is removed, the endfaces are pushed (or pulled) even more tightly against each other by these thermally contractive forces which, in essence, are a pair of frictional forces, oppositely-directed towards each other, and imposed upon the surfaces of the two fibers by the shrinking ferrule as it cools and contracts, where optical signal loss at the junction is further reduced.

Unless the two mated fibers are manually pulled and/or twisted in opposite directions, e.g., inadvertently, the radially-directed compressive forces and the surface frictional forces resulting from the heat shrink process are the only forces upon the outer cylindrical surfaces of the embedded optical fibers. However, after the plastic ferrule has cooled, and after the spliced junction is pressed into service with optical signals passing therethrough, should the fibers inadvertently be pulled and/or twisted in a manner that might otherwise tend to separate and undo the mechanical splice, there are additional strong, longitudinally-directed and/or circumferentially-directed, frictional forces imposed on the fibers from the shrink wrap ferrule to hold the fibers in place and prevent the robust splice from being undone.

All of the longitudinally-directed frictional forces (F_{L}) resist pulling the splice apart and the circumferentially-directed frictional forces (F_{C}) resist twisting the splice apart. Both of these frictional forces, F_{L} and F_{c}, can be made relatively strong at least because the ferrule tube can be made relatively long. There is no ferrule-length limitation other than a practical length limitation. The strength of these two frictional forces is proportional to the length of the ferrule tube, other considerations aside. The mechanical only splice provided by exemplary embodiments cannot be inadvertently pulled apart nor twisted apart by a technician exerting ordinary hand force. The glass fiber would most likely fracture before the splice junction fractures or fails.

In further features of the described embodiments, the plastic ferrule is formed with circular openings on opposite ends, or side walls, of the ferrule that are larger in diameter than the diameters of the optical fibers to be inserted therein. This is to permit ease of insertion of the fibers into the aperture of the ferrule. There is a tapering from those larger diameter openings, via conical walls formed inside, and at the ends of, the plastic ferrule, to the smaller diameter of the aperture that is intended to snugly encapsulate the optical fibers. The tapering is in the shape of a funnel. In one exemplary embodiment, the outer diameters of the optical fibers can be approximately 125 microns and the diameter of the cylindrical aperture can be approximately 130 microns offering a small clearance to aid insertion. A larger clearance can be used. The larger diameter openings on either end of the plastic tube can be approximately 600 microns, more or less. There is no restriction on relative sizes or proportions of optical fiber diameters, clearances and openings, and virtually any sized glass optical fiber can be successfully spliced by the embodiments disclosed herein.

In addition, after insertion of the optical fibers, epoxy can be applied to the exposed conical surfaces on either end of the plastic ferrule, further contributing to the integrity of the splice junction by tightly sealing the optical fibers in a manner that is almost impervious to humidity, water and other environmental interferences. If there are epoxies that currently exist, or that are subsequently developed, that offer hermetic sealing power when used with glass and plastic, then such hermetic seal is contemplated with an exemplary embodiment. Alternatively, if other than an epoxy seal is used, such as, e.g., a ceramic seal, which provides a hermetic seal when used with glass and plastic, that hermetic seal is likewise contemplated with an exemplary embodiment. Furthermore, these epoxy seals, which bind the ends of the ferrule to the bare-glass of the optical fibers protruding from both ends of the ferrule, offer additional frictional forces, combining with the other above-described frictional forces, in opposition to any attempt to undo the mechanical-only splice by pulling and/or twisting (intentionally or inadvertently) on the optical fibers in opposite directions. The epoxy can be of the type that utilizes ultraviolet (UV) light to cure (harden) it, or can be an epoxy that does not need/use UV light.

In a particular methodological exemplary embodiment, optical fibers are stripped bare from their respective buffer coatings to obtain bare glass (core and cladding) fiber surfaces. (In this document bare glass fiber means the combination of a glass core which can be approximately 10 μm diameter surrounded by its glass cladding which can be approximately 125 μm diameter, although both of these dimensions can vary; the exemplary embodiments can be sized to operate upon any optical fiber.) The optical fibers are then cleaved at a desired angle relative to what shall be the direction of transmission of light through the fibers, to obtain cleaved ends. The cleaved ends and the bare optical fibers are then cleaned to prepare the cleaved ends for being mechanically-spliced together. Each cleaved end is inserted into a large opening at its respective end of an aperture formed through the plastic ferrule, but only after applying index matching gel to either cleaved end. The insertion constrains angular orientation of the inserted optical fibers to ensure coplanar interfacing of the cleaved ends within the aperture. Then, the plastic ferrule is heated to a sufficiently high temperature to heat shrink the plastic ferrule upon the inserted optical fibers to achieve a permanent mechanical-only splice between the inserted fibers.

In a further feature of this methodology, the index matching gel is applied by inserting a pin coated with the gel into the aperture prior to inserting the cleaved ends into the aperture. And, in yet another feature of this methodology, the index matching gel is applied by depositing the gel to either or both conical surfaces, thereby allowing the cleaved ends to acquire the gel automatically as the optical fibers are guided by the gel-covered conical surfaces into the aperture.

For optical fibers that are both cleaved at the same angle which is other than perpendicular to the intended direction of optical transmission through the fibers, e.g., an angle of eight (8) degrees which is typical for mitigating adverse effects of signal reflected from the splice junction, this methodology automatically and inherently mitigates any ramping that might occur during coplanar interfacing of these angled cleaved ends. “Ramping” refers to the tendency of the coplanar cleaved ends of the fibers to slide relative to each other because of longitudinally-directed forces derived from a pushing-together of both fibers when a technician, or other person, is creating the mechanical splice. As noted, if the diameter of the optical fibers is 125 microns and if the inner diameter of the ferrule aperture or channel is 130 microns, thereby providing a 5 micron diameter clearance, then each fiber could “ramp” to an extent of a radial displacement of 2.5 microns.

The ramping effect reduces desired full congruency, or 100% overlap, between the two surfaces, and in-congruency contributes to optical signal loss (insertion loss) when an optical signal is applied to one end of the spliced-together optical fiber. Because of the radially-directed compressive force derived from the collapsing plastic of the ferrule during the shrink-wrap process, the displaced cleaved ends resulting from the ramping tend to be pushed back in the direction towards full cleaved-end congruency. Even if full congruency is not achieved, the insertion loss is mitigated relative to what the loss would have otherwise been, prior to the effects of the compressive shrink forces provided by exemplary embodiments.

For optical fibers that are both cleaved at the same angle which is other than perpendicular to the intended direction of optical transmission through the fibers, e.g., an angle of eight (8) degrees as noted above, this methodology automatically and inherently aligns the angular orientation of both cleaved fibers to provide coplanar touching between the two fiber ends, at the splice junction. Without adjusting relative angular orientation of the two fibers, both optical fibers can be linearly displaced in opposite directions towards each other and parallel to the longitudinal axis of the plastic ferrule aperture, whereby each optical fiber end is inserted into an opposite end of the plastic ferrule aperture until the ends touch, resulting in coplanar optical fiber cleaved ends.

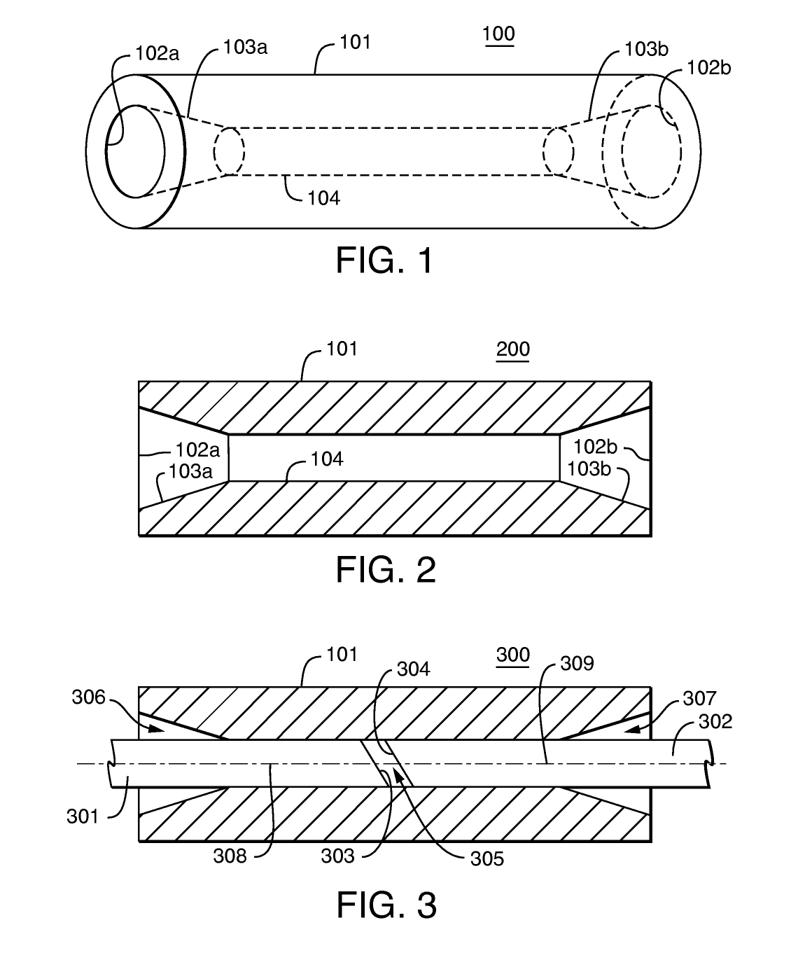

FIG. 1 is an exemplary schematic diagram of plastic shrink-wrap ferrule or hollow plastic tube 100, an embodiment configured in accordance with an exemplary embodiment. Plastic tube body 101 is firm or hard at room temperature, can be made from commercially-available shrink-wrap plastic tubing such as, for example, and not limited to, Polyolefin (Polymerization of Olefins), PVC (Polyvinyl Chloride), FEP (Fluorinated Ethylene Propylene), Teflon (a registered trademark of DuPont—Polytetrafluorethylene or PTFE), PVDF (Polyvinylidene Fluoride-supplied at least by the Vertec Polymers company), Neoprene (a registered trademark of DuPont—Polymerization of Chloroprene) or Fluoropolymer, etc. Plastic body 101 can be cylindrical in shape. Circular openings 102a and 102b are shown at opposite ends of plastic body 101. Conical walls 103a and 103b act as funnels to taper from the relatively larger diameter associated with circles 102a/b to the relatively smaller diameter associated with aperture 104. Aperture or tunnel 104 is formed through, and spans, plastic body 101. Aperture 104 connects to the tapered conical walls on both ends of plastic body 101, as shown, providing a continuous opening within plastic body 101 from one end to the other end. The conical or funnel configuration at either end of ferrule 100 allows easy insertion of optical fibers (not shown in FIG. 1) from either end, the fibers meeting together at or near the midpoint of aperture 104. The proportions presented in FIG. 1 are selected to enhance clarity of illustration; more realistically, the outer diameter of plastic ferrule body 101 could be about two to five millimeters (two thousand to five thousand microns) more or less, while the diameter of aperture 104 is only approximately 125 microns.

FIG. 2 is a cross-sectional view 200 of FIG. 1. The tapered openings resulting from the cone or funnel structure are visible at either end. In a particular embodiment, aperture 104 can have a diameter of approximately 130-140 microns to accommodate a 125 micron diameter glass fiber, and diameters 102a and 102b can be approximately four-five times larger at a dimension of approximately 600-700 microns. Other diameter sizes can be used to accept other sized optical fibers.

FIG. 3 is a modified cross-sectional view 300 of FIG. 1, because it includes glass fibers inserted into the ferrule of FIGS. 1 and 2. Optical glass fiber 301 is inserted into opening 102a from the left-hand side of FIG. 3 and is funneled into aperture 104 at its left end from which it travels in the right direction to approximately the midpoint of aperture 104. Optical glass fiber 302 is inserted into opening 102b from the right-hand side of FIG. 3 and is funneled into aperture 104 at its right end from which it travels in the left direction to approximately the midpoint of aperture 104. In the embodiment shown, cleaved end surface 303 of optical fiber 301 and cleaved end surface 304 of optical fiber 302 are identically angled relative to transverse axes 308 and 309, respectively, of optical fibers 301 and 302. (The transverse axes also represent the direction of propagation of an electromagnetic or light signal being transmitted through optical fibers 301 and 302) Further, the optical fibers are angularly oriented such that the cleaved end surfaces (end faces or ends) are co-planar when they touch. The cleaved end surfaces are elliptical when the fibers are cut on an angle other than 90 degrees and when the optical fibers are cylindrical.

Space 305 is exaggerated only for purposes of enhanced clarity of presentation. Space 305 contains index matching gel (not shown) which had previously been applied to either or both end surfaces of optical fibers 301 and 302, and is used to reduce insertion loss caused by the optical splice junction. Such gel can be applied to the end surfaces of the optical fibers directly, or by depositing the gel onto the conical surfaces at one or both ends of ferrule 100 where the gel would automatically be picked up by ends 303 and 304 of the glass fibers upon insertion of the glass fibers into the funnels. The space 305 shown between parallel cleaved ends 303 and 304, in actual construction of this embodiment, would not be as large as that shown in FIG. 3 because cleaved ends 303 and 304 are essentially coplanar, separated only by a thin gel layer. The empty space remaining in aperture 104 after the glass fibers are inserted, due to the intended diameter-tolerance provided, accepts excess gel, if any, upon pressing both optical fibers towards each other. The movement of both optical fibers towards each other is accomplished by both the technician inserting the fibers into the aperture and by thermal contraction resulting from cooling the ferrule after the heat shrinking has occurred. This thermal contraction is described in more detail elsewhere in this document.

After insertion of optical fibers 301 and 302 into the two funnels at opposite ends of ferrule 100, spaces 306 and 307 are formed at opposite ends of ferrule 100, encircling both fibers. If gel was applied to either or both of these surfaces, after wiping away residual gel, if any, from these surfaces, these spaces can be filled with commercially-available epoxy which bonds the glass fibers to plastic body 101. The epoxy can be of a type that uses ultraviolet light (UV) for curing purposes or can be of a different type that does not need UV light for curing. The epoxy bonding adds to the integrity of the splice because (a) it further seals the shrink-wrapped plastic over the splice junction and (b) it adds resistance to that already provided by the shrink-wrapped plastic against separation of the splice junction if the optical fibers are inadvertently pulled and/or twisted in opposite directions.

FIG. 4 is a top view of optical fiber mechanical splicing apparatus 400, an embodiment in accordance with an exemplary embodiment. Base or chassis 413 is solid, constructed from stiff metal such as steel or the like. The chassis could alternatively be constructed from hard and stiff plastic. Precision groove or channel 414 is configured into base 413, only a portion of the channel floor being visible in FIG. 4. Various holders and splicers, to be discussed, are shown sitting in channel 414 and the channel floor is wider than the portions being shown because the channel walls are slanted, as discussed below.

A top view of channel 414 shown in FIG. 4 without inserted holders and splicers is given in FIG. 5. As seen in FIG. 5, channel 414 is continuous with a single right/left (r/l) section identified as 414r/l and with two up/down (u/d) sections identified as 414u/d. Because the bottom (not shown) of chassis 413 is a plane that is parallel to the plane of the channel floor, when the chassis bottom rests on a horizontal surface the channel floor itself is also horizontal. Because the channel walls are slanted as discussed below, only portions of the channel floor can actually be seen in this FIG. 5 top view. Hidden lines 502a, 502b and 502c represent intersections between walls of channel 414 and the floor of channel 414. There is another such intersection occurring in the vicinity beneath the markings of ruler 501, but is not shown for purposes of increasing clarity of presentation. Of course, chassis base 413 can be made larger to accommodate any slant angle chosen. The width of the channel floor beneath slicer 405 (shown in FIG. 4) is shown in FIG. 5 as “W.”

Continuing with discussion of both FIGS. 4 and 5 taken together, shrink-wrap plastic ferrule 101 is shown supported by ferrule holder 415 in the center of FIG. 4. Ferrule holder 415 is essentially a solid block which is slidably mounted in right/left section 4141r/l of channel 414. Ferrule holder 415 includes a V groove configured into the top of block 415 (the groove being hidden from view by ferrule 101 in this view of this embodiment) to provide a stable support base for ferrule 101. Locking arms 415a and 415b hold the ferrule immobile in/on ferrule holder 415. Funnel openings 102a and 102b (not shown in this Fig.) are at the far left and right ends of holder 415. More will be said about ferrule holder 415 below in connection with FIG. 8.

Aligned in the same right/left linear groove or channel section 414r/I are optical fiber holder 403 at left and optical fiber holder 404 at right. These holders are also solid blocks, and both are slidably mounted in channel 414r/l in the same right/left directions 409 and 410 and positioned in place by limit stops. For example, body of fiber slicer 405 can be used as a limit stop for fiber holder 403 and body of fiber slicer 406 can be used as a limit stop for fiber holder 404. Optical fiber holder 403 supports optical fiber 401 securely under latching arm 403a for cleaving in slicer 405, and optical fiber holder 404 supports optical fiber 402 securely under latching arm 404a for cleaving in slicer 406. The fibers are held sufficiently tightly by these latching arms so that the fibers cannot turn or rotate. Optical fibers 401 and 402 are different and separate optical fibers. Fiber holders 403 and 404 are further discussed

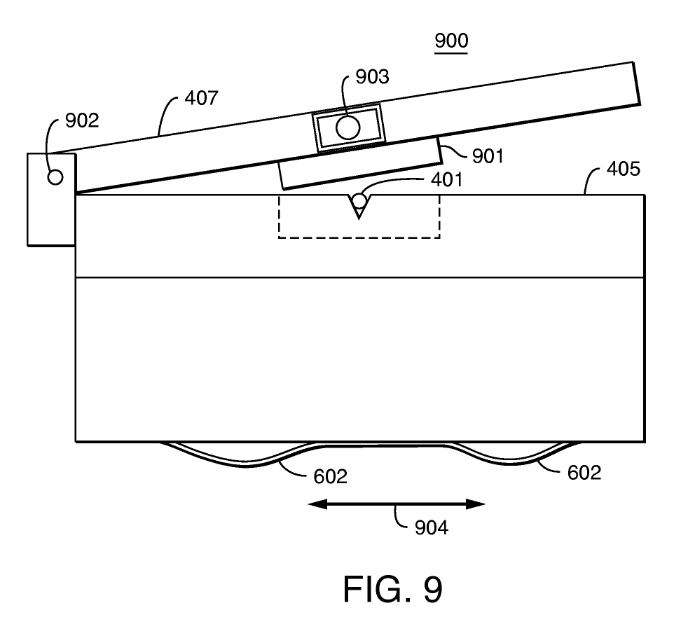

Fiber slicers 405 and 406 are slidably mounted in the 414u/d sections and can slide in directions 411 and 412, respectively. When the fiber slicers are in place as shown, determined by, for example, limit stops against the rear of chassis 413 (not shown in this Fig.), slicing arms 407 and 408 are opened so that optical fibers 401 and 402, respectively, can be inserted therein and sliced or cut. There is a precision angle adjuster, a micrometer-like mechanism, provided on each slicer so that the same slice angle can be obtained on optical fiber 401 and on optical fiber 402. More detail is provided about slicers 405 and 406 below in connection with FIG. 9. In addition, U.S. Pat. No. 7,316,513, entitled “Optical-Fiber Mechanical Splicing Technique” and assigned to the assignee of the present application, is incorporated herein by reference in its entirety.

FIG. 6 is a rear elevation view 600 of the chassis 413 of FIG. 4, but showing only one optical fiber slicer 406 in its channel. The slicers and holders can be completely removed from channel 414 if desired. FIG. 6 also shows the top surface of structure 413 as an edge 606 of a horizontal plane as well as showing the bottom surface of structure 413 as an edge 607 of a horizontal plane. As noted above, and as shown, the channel walls 603 of channel 414 are slanted; they are not perpendicular to channel floor 604. All walls of channel 414 have the same slant, but only the slanted walls of channel sections 414u/d are shown in this view. The various slicers and holders have a matingly-compatible slant to their respective sides, wherefore this angular offset prevents the various slicers and holders from falling out of the chassis, should apparatus 400 be inadvertently overturned, because the slicers and holders are held by the slanted walls within their respective channels. In addition, to ensure a precise fit and stable operation, leaf springs such as leaf spring 602 can be affixed to the bottoms of all slicers and fiber holders, to provide appropriate mating force upon them by pushing them upward and against their respective slanted walls. The horizontal plane of the floor of the channel is shown on edge as dashed line 601. A limit stop 605 is shown for fiber slicer 406.

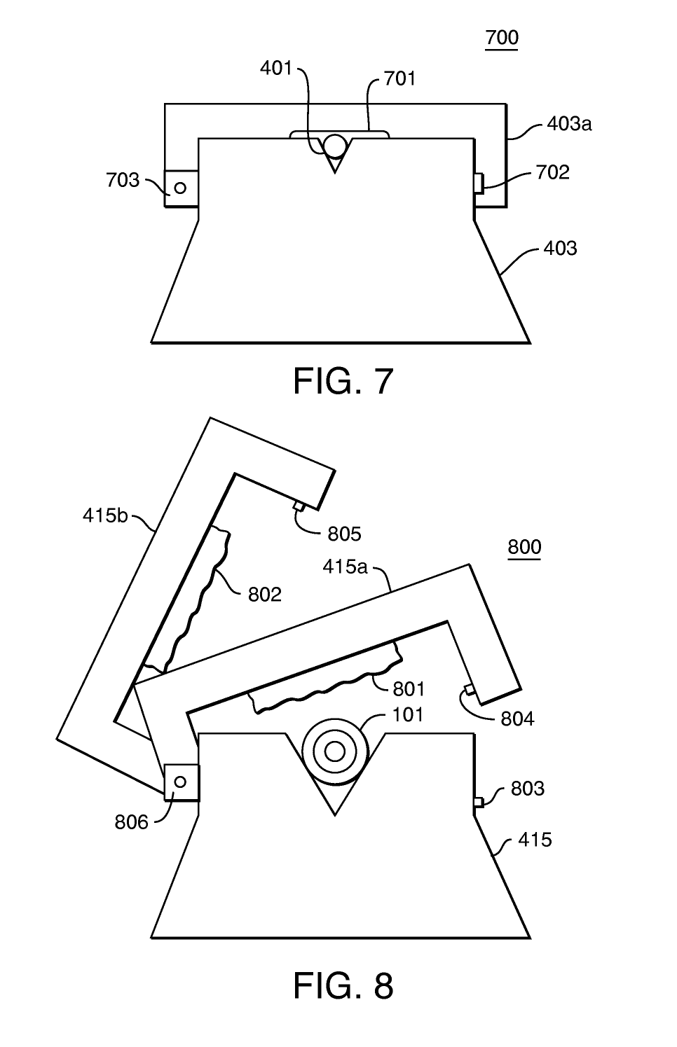

FIG. 7 is a side elevation view 700 of the optical fiber holder 403 of FIG. 4 and viewed from the left hand side of FIG. 4, where holder 404 is hidden from view by holder 403. The holder body 403 is shown with slanted sides to mate with the slanted walls 603 of the channel. Optical fiber 401 (optical fiber 402 being hidden from view by 401) is shown seated within a V groove configured into the top of holder 700. The optical fiber is held in place by force applied from locking arm 403a (404a hidden by 403a) via soft pad 701 attached to the locking arm. The locked fiber cannot move translationally or rotationally. The locking arm is shown in a locked state, and it is held in that state by latching mechanism 702 in cooperation with hinge 703 (the hinge and latch for holder 404 are hidden from view by hinge 703 and latch 702, respectively). In an unlocked state, latching arm 403a swings open around the axis of hinge 703 (as does latching arm 404a with respect to its hinge, not shown). The locking arm can be made from flexible plastic to enable latching mechanism 702 to be readily latched and unlatched by a technician, as desired. The locking arm is positioned central to glass optical fiber holder 403 or 404, as shown in FIG. 4, and is relatively wide (in the longitudinal direction of the fiber) enabling a wide dimensioned pad 701 which ensures good holding control over its respective clamped optical fiber. Holders 403 and 404 can be identically constructed and dimensioned, and are interchangeable.

FIG. 8 is a side elevation view 800 of plastic ferrule holder 415 depicted in FIG. 4 and constructed in accordance with an exemplary embodiment. The body of ferrule holder 415 is shown in FIG. 8 with slanted sides to mate with the slanted walls 603 of the channel. As noted, all slanted walls of channel 414 can have the same slant. Ferrule 101 is shown seated within a V groove configured into the top of ferrule holder 415. The V groove for the ferrule in FIG. 8 is much larger than the V groove for the optical fiber in FIG. 7. The ferrule is held in place by force applied from locking arms 415a and 415b via soft pads 801 and 802 attached, respectively, to locking arms 415a and 415b. The locking arms are shown in an un-locked state but can be held in a locked state by latching mechanisms in cooperation with their respective hinges; for example, note that mechanism 803/804 cooperates with hinge 806. (Mechanism 805 cooperates with a mechanism similar to 803 and which is hidden from view by 803.)

In the depicted unlocked state, latching arms 415a and 415b, respectively, swing open around the axes of hinge 806 and another hinge associated with locking arm 415b and which is hidden in this view by hinge 806. The locking arms can be made from flexible plastic to enable the latching mechanisms such as 803/804 to be readily latched together and unlatched by a technician, as desired. The locking arms are positioned towards opposite ends of plastic ferrule holder 415, as shown in FIG. 4, to avoid imposing pressure on the ferrule in the vicinity of the splice, and are relatively narrow to avoid being near the central location of the ferrule holder. Two narrow-width soft pads 801 and 802 ensure good holding control over the clamped ferrule 101. The locked ferrule does not move translationally or rotationally.

FIG. 9 is a side elevation exemplary schematic view 900 of optical fiber slicer 405 depicted in FIGS. 4 and 6, and constructed in accordance with an exemplary embodiment. This is a view of slicer 405 from the left hand side of FIG. 4. Optical fiber 401 sits in a V groove atop slicer 405 as shown, and slicing arm 407 carries a sharp blade 901, not unlike a razor blade, and is rotated around hinge 902, to cause shearing of the optical fiber in a precise manner. A mechanism 903, such as an adjustable micrometer mechanism incorporated in slicing arm 407, can be used for adjusting orientation of blade 901 relative to the longitudinal axis of arm 407. Slicer 406 is constructed, dimensioned and operated essentially the same as construction and operation of slicer 405, with an identical adjustable micrometer mechanism. Slicers 405 and 406 are interchangeable.

Further, a clamping mechanism, not shown, for securing optical fiber 401 or 402 against the V groove in FIG. 9 prior to making the cut, can be provided. The clamping mechanism does not interfere with the slicing action of blade 901. An alternatively-designed slicer can use two sharp blades, blade 901 shown with sharp edge facing down and another blade (not shown) supported by slicer 405/406 with sharp edge facing up. Commercially available optical fiber slicers, for cutting glass optical fibers, can be used instead of that disclosed in FIG. 9. Furthermore, a slicer in accordance with that disclosed in the incorporated-by-reference patent identified above can be modified as may be necessary and employed herein.

FIG. 9 also shows leaf spring 602 affixed to the bottom of slicer 405. Another identical leaf spring (not shown) is used for slicer 406 (not shown). The leaf spring, sliding against the floor of channel 414 in directions 904, imposes an upward vertical force perpendicular to the bottom of apparatus 400, causing apparatus 406 to press against slanted walls 603, thereby adding stability to operation of the slicer. The upward force from the leaf spring can be configured to exceed the downward force needed to slice the optical fiber by at least one order of magnitude (10:1). Separate leaf springs are attached to the bottoms of each slicer and holder and are used to add stability to operation of each component in the embodiment, but are shown only in FIG. 9 and in FIG. 6 to enhance clarity of presentation. Alternatively, when the components and the channel are manufactured or machined with sufficient precision so that they mate essentially perfectly, the leaf springs are not needed.

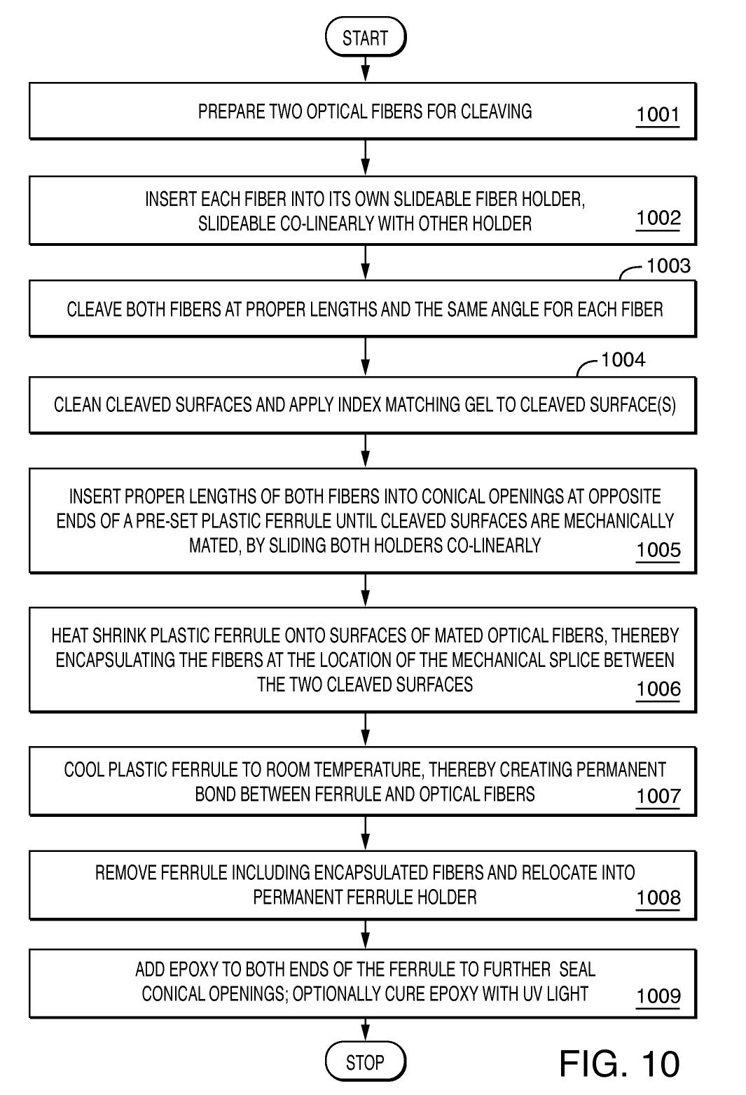

FIG. 10 is a flowchart depicting operation of a disclosed embodiment under control of a trained fiber-optic technician who performs or controls all of the following steps. In step 1001 optical fibers 401 and 402, which are two different and separate glass optical fibers made from glass or plastic, are prepared for cleaving or slicing. For glass fibers, this requires, at a minimum, stripping the outer insulation and buffer coating. (The outer insulation can be an outer jacket approximately 1-5 millimeters in diameter made from plastic such as PVC or HDPE. The outer insulation encapsulates a buffer coating which is approximately 250 to 900 μm in diameter made from plastic such as two layers of acrylate—one soft layer and one hard layer that may be reinforced for added strength) The outer insulation and buffer coating are stripped from both fibers sufficiently to expose adequate lengths of bare glass (glass core plus glass cladding) with which to work. Further, components 403, 404, 405, 406 and 415 are pre-positioned by the technician properly in channel 414.

In step 1002, each bare glass fiber is seated into a V groove within its respective fiber holder, 403 or 404. In step 1003, if a 90 degree cut is not going to be made, the angle of cut is adjusted in slicers 405 and 406 to both be the same angle (which could be 82 degrees or some other chosen angle). Each angle is measured from the longitudinal axis of the glass fiber at the location of the slice. Each measurement is made in the same clockwise or the same counterclockwise direction for both cuts. Both optical fibers are cleaved or sliced at that angle. In step 1004, with the optical fibers continuing to be held rigidly within their respective holders 403 and 404 which ensures that the orientation of the fibers is held fixed, the cleaved ends of the fibers are cleaned. Index matching gel can be applied to one or both ends at this step.

In step 1005, slicers 405 and 406 are slid within their respective sections of channel 414u/d so that they are out of the way of channel 414r/l. Then both holders 403 and 404 are slid in channel 414r/l towards each other until each cleaved end of both optical fibers enters its respective conically-shaped opening in shrink wrap ferrule 101. In performing this action, the performing technician utilizes linear scale 501 to aid in visually estimating the appropriate distance for each fiber so that they meet within ferrule 101 at approximately the middle of the length of the ferrule. The cuts are automatically oriented properly because the optical fibers have not rotated; they were held rigidly in their respective holders. The insertions are continued by the technician until a slight bending of the fibers outside of the ferrule is noticed by the technician, indicating that a firm interface has been achieved internal to the ferrule.

In step 1006, heat is applied to the plastic heat shrink ferrule, which can be applied from a commercial heat gun. The heat is sufficient to shrink the plastic ferrule without melting it and without melting the mated glass fibers encapsulated within the ferrule. The plastic ferrule collapses upon the surfaces of both optical fibers, covering the entire outer cylindrical surface of each fiber contained within the ferrule, regardless of any eccentricity or distortion that might be present in each fiber surface, and regardless of any variation in diameters between the fibers. In step 1007, the ferrule is cooled to room temperature while it remains in ferrule holder 415 and remains motionless until adequately cooled. Consequently, shrink wrap ferrule 101 has tightly clamped-down radially upon the outer cylindrical surfaces of the encapsulated bare optical fibers while it simultaneously has caused the endfaces of the two fibers to be pulled/pushed together because the linear coefficient of thermal contraction of the plastic ferrule is greater than that of the glass fibers. In this manner, the mechanical-only splice between the two cleaved ends of the two optical fibers is made permanent. This shrink wrap action, by itself, creates a permanent bond between the ferrule and the optical fibers contained therein. The strength of the splice is proportional to the length of the ferrule, and there is no limit, but for a practical limit, to the length of the ferrule; embodiments discussed herein contemplate ferrules of any length and ferrule lengths of up to eight or more inches may be the norm.

In step 1008, the cooled ferrule including the encapsulated fibers are removed and relocated into a permanent ferrule holder which may have certain similarities in construction to ferrule holder 415, such as, e.g., having a V groove and two separated clamping arms, like those shown in FIG. 8, but different at least in the respect that it is capable of holding a plurality of splices and not designed for sliding or moving in a track. In step 1009, in the permanent ferrule holder, epoxy can be added to both ends of the ferrule to further tightly seal the conical openings 306 to such an extent that it may be a hermetic seal; the epoxy adds to the strength and integrity of the mechanical splice; the epoxy can be the type that is cured by UV light or can be self curing without UV.

If index matching gel is not applied in step 1004, optionally it can be applied in step 1005 by depositing it onto a conical surface at one or both ends of the ferrule. In this way,

[symbol]

The process provides an easily-obtained mechanical-only splice, without reliance upon a fusion splice or other splice. The obtained splice is permanent, reliable and robust because it cannot be pulled apart under ordinary usage conditions. Further, the process automatically or inherently provides for correct angular orientation of the optical fibers if the cleaved ends are sliced on an angle, and inherently mitigates any ramping effect derived from that angle slice.

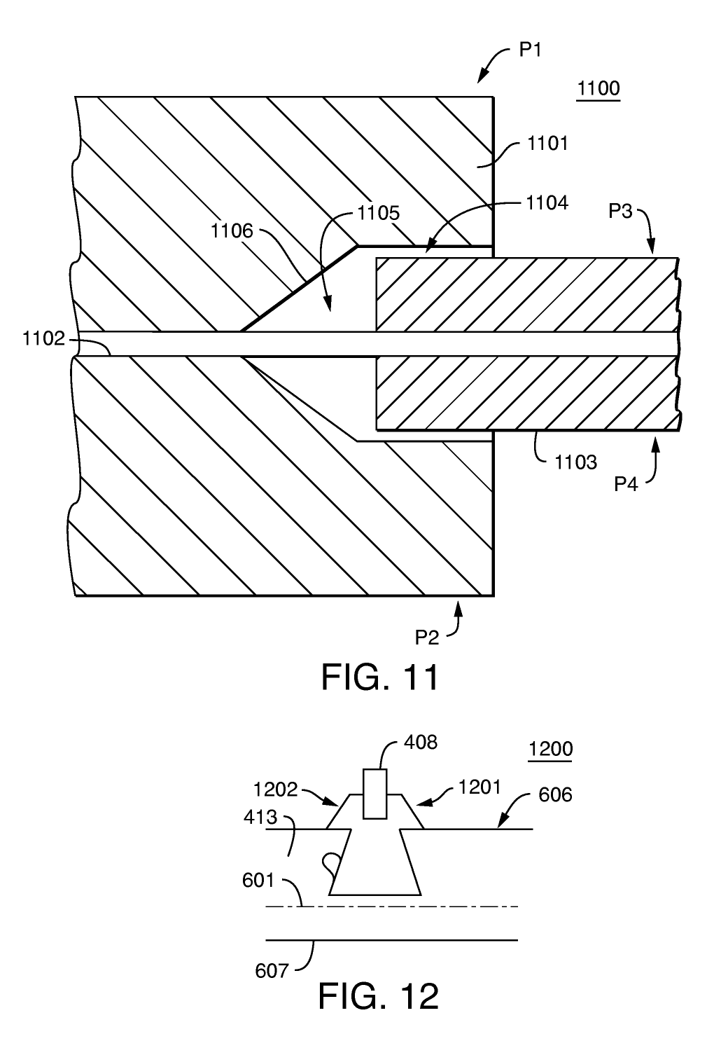

FIG. 11 is a cross-sectional view of one end of another plastic ferrule embodiment 1100 in accordance with an exemplary embodiment, this plastic ferrule being similar to that of FIG. 3 but also engaging the buffer coatings of the optical fibers (only one of the optical fibers shown in FIG. 11) in a manner to protect a portion of that optical fiber which otherwise would be exposed. Initially, an appropriate length of buffer coating is stripped from the end of an optical fiber and the resulting bare glass end is inserted into plastic ferrule 1101. Ferrule 1101 is shown in cross Section resulting from a vertical plane slicing through it. Optical glass fiber 1102 is shown embedded within ferrule 1101 and also shown encapsulated by buffer coating 1103. Optical glass fiber 1102 has been cleaved (not shown) at an appropriate length to achieve both a proper mating of its end face with another glass fiber (not shown) in the aperture within plastic ferrule 1101 as well as an insertion of an end portion of buffer coating 1103 towards and/or into the space of funnel 1106.

When optical fiber 1102 is inserted into the aperture of ferrule 1101 followed by insertion of attached buffer coating 1103 into cylindrical aperture 1104, buffer coating 1103 almost touches funnel 1106 as shown. A small clearance gap is provided, between buffer coating 1103 and cylindrical aperture 1104, as shown, to allow ease of insertion of the buffer coating. Cylindrical aperture 1104 is contiguous with the largest periphery of funnel 1106 and circumscribes buffer coating 1103 to a substantial overlapping distance; this distance can be varied, by using differently sized ferrules for different applications. When heat shrinkage occurs, ferrule 1101 tightly compresses upon the entire structure, thereby filling in space 1105 around optical fiber 1102 and filling in the gap around buffer coating 1103, thereby forming a tight seal. After heat shrinkage occurs, and cool-down occurs, epoxy can be applied to the ferrule/buffer coating interface to further seal that interface.

FIG. 11 has proportions that are realistic. If the diameter of the optical glass fiber 1102 is taken to represent 125 microns, the diameter of the buffer coating 1103 is shown to be about 875 microns, the diameter of the funnel opening 1106 at its widest (and, thus the diameter of the cylindrical aperture 1104) is shown to be about 975 microns and the diameter of the ferrule 1101 prior to heat shrinking is shown to be about 2500 microns. Other dimensions and proportions could have been employed, and the depiction in FIG. 11 is purely exemplary. After heat shrinking, not only is the internal splice between two glass endfaces protected and sealed by operation of the shrinking process described above which, by itself, prevents pulling, and/or twisting, apart of a purely mechanical splice but, with this embodiment, the ends of the ferrule are also shrunk over a post-epoxied, buffer coating which creates complete encapsulation from a first buffer coating on one fiber to a second buffer coating on the other fiber. The other end of ferrule 1101 is not shown to allow presentation of a large view of one end of the ferrule which enhance clarity of presentation. However if the other end were shown, it would essentially have been a mirror-image version of the depiction of FIG. 11.

In this specification, various preferred embodiments have been described with reference to the accompanying drawings. It will, however, be evident that various modifications and changes may be made thereto, and additional embodiments may be implemented, without departing from the broader scope of the invention as set forth in the claims that follow. For example, rubber boots can be utilized as follows: Before the optical fibers are inserted into the ferrule, each of two approximately 125 micron diameter optical fibers to be spliced, further encapsulated by their respective 250-900 micron diameter buffer coatings, is inserted through a rubber boot so that the boots are snugly but still slideably positioned around their respective buffer coatings and away from the activity of the splice.

After heat is applied to the ferrule generating heat shrinkage, and after cooling the ferrule whereupon the shrinkage upon the inserted optical fibers is made permanent, an epoxy is applied to each end of the cooled ferrule and to the outer periphery of the fiber buffer coatings near the ends of the buffer coatings located near ends of the ferrule. (This is discussed below in further detail in connection with P1, P2, P3 and P4 of FIG. 11.) The epoxy is applied to all intended surfaces after occurrence of the heat shrink but before each boot is slid along its buffer coating in the direction of the ferrule. Then, the boots can be slid from their remote positions on the buffer coatings to the ferrule so that one end of each boot can be stretched over a respective end of the epoxied ferrule (the ferrule possibly being some 2-3 millimeters or 2000-3000 microns in diameter, more or less, after shrinkage). The ferrule/boot interfaces can then be made permanent because of the previously-applied epoxy that cures at those interfaces. Also the other ends of the rubber boots can be permanently epoxied to the outer surfaces of the fiber buffer coatings because of the previously applied epoxy that cures at those other interfaces.

The end result is that both boots extend axially in both directions from ends of the ferrule to their respective buffer coating, thereby encapsulating the bare optical fibers (cladding encapsulating core) that would otherwise have been seen extending out from opposite ends of the ferrule without this rubber boot alternative embodiment. Each rubber boot would look something like a truncated cone, with the smaller diameter of the cone epoxied around the 250 to 900 micron fiber buffer coating and the larger diameter of the cone epoxied around the 2-3 millimeter (shrunk) ferrule. This alternative embodiment provides protection of the bare glass optical fibers that would otherwise be exposed at each end of the ferrule.

Referring back to FIG. 11, if this diagram were to represent a structure upon which rubber boots were being used, locations P1 and P2 are places on the periphery of the ferrule where epoxy would be placed by encircling the entire periphery of the ferrule with epoxy. Locations P3 and P4 are places on the periphery of the buffer coating where epoxy would be applied by encircling the entire periphery of the buffer coating with epoxy. Then, the rubber boot, not shown in FIG. 11, would be slid from right to left until it overlapped P1/P2 as well as P3 and P4, and it would be permanently epoxied in place when the epoxy cured. This presupposes that the ferrule was previously heat shrunk, but the epoxy locations and technique remain the same. In fact, both the buffer-coating-funnel-penetration technique associated with FIG. 11 above and the rubber boot technique can both be used together if deemed desirable.

Referring to FIG. 12, an exemplary schematic diagram of an alternative configuration 1200 of the slicer of FIG. 6 is shown. Slicer 1200 is functionally equivalent to that of FIG. 6. However, slicer 1200 is fashioned with shoulders 1201 and 1202 which rest upon surface 606 of base structure 413. Those shoulders, in cooperation with the slanted sides of the slicer, in further cooperation with the matingly-fitted channel in which the slicer slides, hold the slicer in the channel appropriately to ensure proper operation without need for leaf spring 602, assuming all parts are precisely machined. The leaf spring could be used as well. The same shoulders configuration can be used with all holders and slicers, namely holders 403, 404 and 415 and slicers 405 and 406. Judicious usage of ordinary lubricant in the channel may be controlled by the technician.

For another example, although plastic optical fibers were not discussed in detail, to the extent that plastic optical fibers are or become viable, and to the extent that those fibers would not be negatively impacted by heat from the heat gun used to cause the ferrule to shrink-wrap, those fibers could also be spliced in accordance with operation of the embodiments presented herein. In addition, the size of the V grooves herein could be made larger or smaller. Furthermore, the soft material used to clamp the optical fibers immobile could be soft rubber, or other similar material. The present invention is thus not to be interpreted as being limited to particular embodiments and the specification and drawings are to be regarded in an illustrative rather than restrictive sense.

What is claimed is:

1. Apparatus, comprising:
a plastic ferrule including a cylindrical aperture formed within said ferrule and spanning said ferrule from one end of said ferrule to an opposite end of said ferrule, said aperture having an inside diameter approximately equal to, but larger than, diameters of two optical fibers selected to be only mechanically spliced together, without fusion, said aperture having said inside diameter when temperature of said ferrule is at a first temperature and having different inside diameters identical, respectively, to said diameters of said two optical fibers when said temperature of said ferrule is at a second temperature higher than said first temperature, provided that ends of said two optical fibers were previously inserted into said aperture and mated-together when diameter of said aperture was equal to said inside diameter, one said end of said two optical fibers being inserted from said one end of said ferrule and the other said end of said two optical fibers being inserted from said opposite end of said ferrule, whereby said ferrule tightly clasps, and permanently retains, said mated-together two optical fibers in a mechanical splice.

2. The apparatus of claim 1 wherein said different inside diameters remain identical, respectively, to said diameters of said two optical fibers and said ends of said optical fibers remain mated together after said temperature of said ferrule is reduced from said second temperature.

3. The apparatus of claim 2 wherein said aperture is conically flared at said one end of said ferrule and at said opposite end of said ferrule to facilitate insertion of said optical fibers into said aperture.

4. The apparatus of claim 3 wherein forces upon said mated-together optical fibers from said plastic ferrule are created after said temperature of said ferrule is reduced from said second temperature to said first temperature, said forces being both compressive forces radially directed towards longitudinal axes of said mated-together optical fibers and friction forces longitudinally directed oppositely to each other on said fibers to push/pull together said ends of said optical fibers.

5. The apparatus of claim 4 wherein said forces upon said mated-together optical fibers from said plastic ferrule include additional longitudinally-directed friction forces holding together said mated-together optical fibers when said mated-together optical fibers are pulled in opposite directions.

6. The apparatus of claim 4 wherein said mated-together optical fibers are mated together in a plane orthogonal to direction of transmission of light through said optical fibers.

7. The apparatus of claim 4 wherein said mated-together optical fibers are mated together in a plane angularly-displaced by approximately eight degrees from a plane orthogonal to direction of transmission of light through said optical fibers.

8. The apparatus of claim 1 wherein said ends of said optical fibers are mated together via index-matching gel applied to either or both of said ends of said optical fibers.

9. The apparatus of claim 1 further comprising:
epoxy applied to said one end of said ferrule and to said opposite end of said ferrule to ensure that said ferrule forms a seal around said inserted two optical fibers, said seal being selected from the group of seals consisting of a hermetic seal and a non-hermetic tight seal.

10. A method, comprising:
baring optical fibers from their respective buffer coatings to obtain bare glass fiber surfaces;
cleaving said optical fibers at a desired angle relative to direction of transmission of light through said fibers to obtain cleaved ends;
cleaning said optical fibers including said cleaved ends to prepare said optical fibers including said cleaved ends for mechanically splicing a cleaved end of one of said optical fibers to another cleaved end of another of said optical fibers;
inserting both said cleaved end of said one of said optical fibers into one end of an aperture formed through a plastic ferrule and said cleaved end of said another of said optical fibers into the other end of said aperture, but only after applying index matching gel to either said cleaved end, said inserting constraining angular orientation of said inserted optical fibers to ensure coplanar interfacing of said cleaved ends within said aperture; and
heating said plastic ferrule to a sufficiently high temperature to heat shrink said plastic ferrule upon said inserted optical fibers to achieve a permanent mechanical splice between said inserted optical fibers.

11. The method of claim 10 further comprising:
applying epoxy to said one end of said aperture and said another end of said aperture to ensure a tight seal between said plastic ferrule and said inserted optical fibers.

12. The method of claim 11 further comprising:
curing said epoxy with UV light.

13. The method of claim 9 wherein said applying index matching gel to either said cleaved end further comprises either:
inserting said gel into said aperture by inserting a pin coated with said gel into said aperture prior to inserting said cleaved ends into said aperture; or
depositing said gel to either or both conical surfaces allowing said cleaved ends to acquire said gel as said optical fibers are guided by said conical surfaces.

14. The method of claim 10 further comprising:
mitigating, automatically and inherently, any ramping that occurs during said coplanar interfacing of said cleaved ends by operation of radially-directed forces upon said inserted optical fibers resulting from said heat shrink.

15. The method of claim 10 wherein said cleaving further comprises:
utilizing two cleavers aligned in parallel and separated by a distance sufficient to permit deployment of a holder of said plastic ferrule within said distance, said holder being oriented perpendicular to the parallel orientation of said cleavers;
setting said two cleavers to cleave at the same angle, by operation of a respective angle adjuster on each of said two cleavers;
inserting said two optical fibers, respectively, into said two cleavers and operating said two cleavers to obtain cleaved surfaces in each of said optical fibers, said cleaved surfaces necessarily being parallel to each other; and
removing cleaved optical fibers from said cleavers and sliding said cleavers in a direction perpendicular to, and sufficiently displaced from, the longitudinal axis of said aperture to avoid intersection with said axis.

16. The method of claim 15 wherein said inserting said cleaved ends further comprises:
sliding a first optical fiber holder, holding one of said optical fibers in the orientation in which it was held during said operating of said cleavers, so that the longitudinal axis of said one fiber moves along said aperture longitudinal axis in a first direction until said one of said optical fibers is inserted an appropriate distance into said aperture; and
sliding a second optical fiber holder, holding the other one of said optical fibers in the orientation in which it was held during said operating of said cleavers, so that the longitudinal axis of said second other fiber moves along said aperture longitudinal axis in a direction opposite to said first direction until said other one of said optical fibers is inserted an appropriate distance into said aperture;
whereby said cleaved ends of said two optical fibers are automatically mated together in a common plane when said two optical fibers touch each other inside said aperture.

17. A method, comprising:
heat shrinking a plastic ferrule upon two different optical fibers having co-planar cleaved ends, or having parallel cleaved ends if said ends are separated by index matching gel, to obtain a permanent and mechanical-only optical fiber splice junction.

18. Apparatus, comprising:
plastic heat-shrink tubing having a particular length and configured to encapsulate, after heat shrinking, two mechanically-spliced optical fibers, each said optical fiber inserted through a respective end of, and into, said tubing prior to said heat shrinking, said encapsulating preventing said mechanically-spliced fibers from separating, said fibers being spliced without any reliance upon fusion splicing or other non-mechanical splicing techniques.

19. The apparatus of claim 18 wherein said tubing further comprises:
an indentation formed into each said end of said tubing, each said indentation configured to receive therein an end portion of a buffer coating which encapsulates a respective one of said optical fibers, said buffer coating penetrating said indentation sufficiently to create a tight seal between said buffer coating and said plastic heat-shrink tubing after occurrence of said heat shrinking.

20. The apparatus of claim 19 further comprising:
a pair of tubular rubber boots having two ends, a first end of each of said pair of rubber boots epoxied to a respective one of said ends of said plastic heat-shrink tubing after occurrence of said heat shrinking, and a second end of each of said pair of rubber boots epoxied around an end of a respective one of said buffer coatings so that a tight seal is made between said plastic tubing and said buffer coating on each of said two ends of said plastic tubing.
